(19) United States
(12) Patent Application Publication
(10) Pub. No.: US 2012/0201719 A1
(43) Pub. Date: Aug. 9, 2012

(54) TANK FOR STORING AND WITHDRAWING HYDROGEN AND/OR HEAT

(75) Inventors: Michel Jehan, Fessy (FR); Laurent Pereaud, Thonon (FR); Patricia De Rango, Gieres (FR); Philippe Marty, Saint Martin D'Uriage (FR); Gérard Bienvenu, Viuz en Sallaz (FR)

(73) Assignees: CENTRE NATIONAL DE LA RECHERCHE SCIENTIFIQUE- CNRS--, PARIS CEDEX 16 (FR); MCPHY ENERGY, LA MOTTE-FANJAS (FR)

(21) Appl. No.: 13/496,763

(22) PCT Filed: Sep. 15, 2010
(86) PCT No.: PCT/FR2010/000622

§ 371 Date: May 1, 2012

(30) Foreign Application Priority Data
Sep. 17, 2009 (FR) 0904442

(51) Int. Cl. B01J 19/00

(52) U.S. Cl. 422/198

(57) ABSTRACT

The present invention relates to a tank for storing and withdrawing hydrogen by means of a reversible hydriding/dehydriding reaction, said tank consisting of a thermally insulated chamber that includes a plurality of elements (2) for storing hydrogen in the form of hydrides, each element having at least one surface for exchange with the gaseous hydrogen and at least one heat exchange surface, characterized in that it further comprises a plurality of heat storage elements (3) for preserving and releasing the heat that is associated with the reversible hydriding/dehydriding reaction.

### FIELD OF THE INVENTION

This invention relates to the field of storing and releasing hydrogen, implementing porous elements interacting with hydrogen so as to reversibly form metal hydrides.

The hydriding/dehydriding reaction, for example of magnesium, is dependent on temperature. The hydriding reaction is exothermic and the dehydriding reaction is endothermic.

This principle allows tanks to be produced that enable hydrogen to be stored in a solid, not gaseous or liquid, form, thereby significantly reducing the risks of explosion during tank handling.

These tanks are in particular intended to supply hydrogen to a fuel cell or a heat engine.

These tanks also make it possible to store or capture heat during the hydriding reaction, and to release it during the dehydriding reaction.

### Prior Art

The international patent application WO 9736819 proposes a rechargeable storage device including a recipient in which thermally conductive matrices with open cells retaining a hydrogen storage medium are housed.

A plurality of dividing elements compartmentalize the recipient into chambers. The hydrogen storage medium partially fills certain chambers, but not entirely. The open cell structure of the matrix enables the hydrogen storage medium to migrate between the cells of the chambers.

The American patent application US 2009 155648 describes a storage tank using a metal hydride for automobile applications.

The international patent application WO 2007 1011476 describes a hydrogen storage tank including a tubular container in which cells are arranged, with each cell being comprised of a plurality of small recipients in the form of sectors, with each recipient containing metal hydride powder.

The French patent FR 2924787 also proposes a hydrogen storage tank. This invention relates to a storage tank consisting of at least one solid body formed by a compacted material including metal hydride and a matrix. The matrix is formed by expanded graphite and the metal hydride is a magnesium or magnesium alloy hydride. The tank includes a plurality of solid bodies stacked inside the container according to a stacking direction. Each solid body is in the form of a pellet and is held inside the container so as to provide an annular space between the internal side surface of the container and each solid body. The tank includes a heat exchanger having at least one channeling system for a heat transfer fluid, extending into the container. The tank also includes metal plates threaded over the channeling system alternating with the solid bodies and annular spaces threaded over the channeling system alternating with the metal plates, with each solid body being threaded over a spacer. This channeling system includes a heat transfer fluid supply conduit and discharge conduit, which are substantially coaxial.

The tank also includes solid body heating elements extending through a plurality of solid bodies.

The prior art also includes the patent application US 2001 035281, which describes a hydrogen storage tank including a cylindrical double skin with two modules separated by a peripheral surface enabling hydrogen to pass. The cylindrical hydrogen storage tube includes structure integrating a plurality of hydrogen storage cells containing hydrogen material powders. Hydrogen is produced by desorption by supplying heat coming from a heat transfer fluid.

The American patent U.S. Pat. No. 4,270,360 describes a hydrogen storage device including a tank equipped with two parallel plates, screwed onto the interior wall of the tank. Heating and cooling elements are inserted between the porous plates. They are separated by a fixed distance. A hydrogen storage material is placed between the plates and the heating and cooling elements.

### Problems in the Prior Art

These different solutions have the disadvantage of requiring an external thermal energy source.

In particular, the American patents US 2001 035281 or U.S. Pat. No. 4,270,360 require an external energy source to cause dehydration, and in particular a heating source, and a cooling source for the desorption. These solutions therefore do not enable self-contained storage tanks to be produced, and they have high production costs.

These disadvantages are even more detrimental when the hydrogen storage materials are of the magnesium hydride type, with a high operating temperature, on the order of 300° C. and with a reaction enthalpy greater than 36 million joules (more than 10 kilowatt-hours) per kilogram of stored hydrogen. The solutions proposed by the prior art patents are therefore unsuitable for such reaction heats.

In addition, in the solutions of the prior art, the tank must have a plurality of fluid connections, one for the hydrogen inlet-outlet, another for the arrival of a heat transfer fluid, and another for the discharge of the heat transfer fluid.

The solution described in patent FR 2924787 has another disadvantage: the tubes “bathe” in the phase change material (heat storage material), and are therefore necessarily vertical, resulting in bulk.

This means that there is a limited hydrogen storage volume when satisfactory filling and withdrawal speeds are desired.

Indeed, the interactions with the gaseous hydrogen and the porous material reacting by hydriding/dehydriding are relatively low due to a low exchange surface.

### Solution Provided by the Invention

The invention of the present application relates to the implementation of this material in devices optimized in terms of weight and cost.

The objective of the invention is to make the hydrogen storage systems in the form of magnesium hydride or other metals and alloys of the same type more economical and practical.

To this end, the present invention consists of joining, to each hydride or metal pellet to be hydridized, a heat storage material tank or more specifically of alternating the hydride pellets with sealed unit tanks.

The invention relates, according to its more general interpretation, to a tank for storing and withdrawing hydrogen by means of a reversible hydriding/dehydriding reaction consisting of a thermally insulated chamber including a plurality of hydrogen storage elements in the form of hydrides each having at least one gaseous hydrogen exchange surface and at least one heat exchange surface, characterized in that it also comprises a plurality of heat storage elements 3 for preserving and releasing heat, associated with the reversible hydriding/dehydriding reaction.

Advantageously, the exchange surfaces between at least one of the heat storage elements 3 and one of said hydrogen storage elements 2 has a front exchange surface with one of said hydrogen storage elements 2.

Preferably, the thermal energy necessary for the dehydriding is provided in situ by the heat storage elements, and the tank is not associated with any external heat input means other than to compensate for heat losses.

The term “heat loss” in the present patent refers to losses associated with tank insulation defects and the heat flow associated with the temperature difference between the incoming hydrogen and the outgoing hydrogen. These heat losses do not include the energy necessary for hydriding/dehydriding reactions, unlike in the prior art.

For example, for a storage of five kilograms of hydrogen, the heat losses associated with the isolation defect are on the order of one kilowatt, and those associated with the hydrogen filling are on the order of 4.35 megajoules per kilogram of stored hydrogen, when the hydrogen enters the tank at a temperature of 30 C.

The total losses are therefore lower than 5% of the total enthalpy of the reaction.

The energy necessary for the operation of a tank according to the invention is therefore 20 times lower than the heat input requirements of the solutions of the prior art.

Advantageously, the tank consists of a chamber containing a plurality of cartridges, with each of said cartridges containing a plurality of hydrogen storage elements each having at least one front hydrogen exchange surface and at least one front heat exchange surface, with said cartridges being connected by at least one conduit for the circulation of the hydrogen.

According to a preferred embodiment, the nominal operating temperature is greater than 280° C. and said heat storage elements contain a phase change material.

According to an alternative, said phase change material consists of a metal alloy.

Advantageously, said phase change material consists of a magnesium- and zinc-based alloy.

According to an alternative, said phase change material consists of a salt.

Advantageously, the hydrogen storage material consists of a pellet of hydrides compacted so as to form a solid block. This solution enables the heat exchanges with the heat storage elements to be improved with respect to the solutions of the prior art implementing powdered materials, and the commercial production of the tank to be simplified. Indeed, the powdered materials are dangerous to handle due to their pyrophoric nature. The solution according to this alternative enables solid pellets, in particular with a discoid or toric or prismatic shape, which can be safely handled, to be produced.

This device has the major advantage of enabling the exchange of heat on both faces of the pellets even though, in the system of the prior art, the exchange could occur only radially.

With this arrangement, it is possible to adjust the pressure in the capsule and to have a very low residual volume with maximum contact between the heat storage material and the capsule walls, and therefore with the hydride facing it. Owing to this invention, it is possible to arrange the basic hydride tanks horizontally, and the entire assembly can be moved without any problem.

The invention relates to various embodiments. In particular, the tank can be produced in the form of a single cartridge or as a set of cartridges combined in a chamber forming a modular tank.

According to this latter alternative, the tank for storing and withdrawing hydrogen, characterized in that it consists of a chamber containing a plurality of cartridges, with each of said cartridges containing a plurality of hydrogen storage elements each having at least one front hydrogen exchange surface and at least one front heat exchange surface, with said cartridges being connected by at least one conduit for circulation of the hydrogen.

This solution enables tanks with a capacity suitable for a particular need to be designed, using standardized cartridges forming basic tanks.

According to a first embodiment, the tank also comprises a plurality of heat storage elements for preserving and releasing heat associated with the reversible hydriding/dehydriding reaction, each having a least one front surface for exchange with one of said hydrogen storage elements.

These storage elements ensure the absorption and the release of the heat produced during the hydriding/dehydriding reaction in a passive manner, without providing external energy.

According to an alternative embodiment, not exclusive of the previous one, the tank also comprises a plurality of heat exchange elements working by circulation of a heat transfer fluid for external preservation and release of the heat associated with the reversible hydriding/dehydriding reaction, each having at least one front surface for exchange with one of said hydrogen storage elements.

This embodiment makes it possible to ensure the absorption and release of the heat produced during the hydriding/dehydriding reaction, and optionally to compensate for heat losses for very long-term storages.

According to a first alternative, at least some of said heat elements are contained in a casing made of a thermally conductive material acting as a barrier to the hydrogen and which is resistant to the temperatures and corrosion caused by the heat storage materials and by the hydrogen.

Advantageously, said heat storage elements contain spacers embedded in the phase change material. These spacers rigidify the capsule and prevent it from collapsing when pressure is applied. During hydriding, the phase change material melts and loses its mechanical strength. The spacers enable the shape of the capsule to be preserved and good thermally conductive to be maintained.

According to a second alternative, at least some of said hydrogen storage elements are contained in a casing made of a thermally conductive material acting as a barrier to hydrogen and which is resistant to the temperatures and corrosion caused by the heat storage materials.

According to one embodiment, the front surface of said casing has protuberances forming spacers between the heat element and the frontally adjacent hydrogen storage element.

According to a particular embodiment, the tank comprises a coaxial alternation of hydrogen storage elements and heat storage elements. This alternation can be single, i.e. an alternation of a pair of juxtaposed hydrogen storage elements and a heat storage element, or multiple, i.e. an alternation of a hydrogen storage element and a heat storage element.

According to a first embodiment, said heat storage elements and said hydrogen storage elements are flat volumes, with a discoid shape. The term “flat” means that the thickness of the discoid hydrogen storage element is less than the cross-section of the circular front surface.

According to a second embodiment, said heat storage elements and said hydrogen storage elements are flat volumes, with a toric shape.

According to a third embodiment, said hydrogen storage elements and said heat storage elements have a tubular shape.

Preferably, said heat storage elements and said hydrogen storage elements are inserted by diffusers made of a thermally conductive material and having hydrogen supply passages.

According to a particular alternative, the tank consists of at least one cartridge containing a stack formed by an alternation of hydrogen storage elements and heat elements, with said tank comprising a thermally insulated external casing.

Advantageously, said cartridge consists of a tubular chamber, having a hydrogen supply opening and defining an internal hydrogen circulation volume, in which a stack of alternating hydrogen storage and heat elements compressed together by at least one spring bearing on the internal surface of said chamber and on the front face of the last element of said stack is arranged.

According to another embodiment, the hydrogen storage elements and the heat exchange elements have a planar shape and have at least one through-opening for the passage of a hydrogen supply tube.

According to a particular alternative, the hydride pellets are toric and encapsulated, and sealed toric phase change alloy capsules pre-formed by smelting are placed between them.

Preferably, a light excess volume is provided in the heat storage material capsules in order to maintain a significant pressure after the fusion of the heat storage material in order to balance the external pressure during the hydriding/dehydriding.

Advantageously, the volume of the heat storage material is adjusted so that the differential pressure between the two sides of the capsule walls is adapted to the mechanical and thermal characteristics of the capsules.

According to an alternative, a drainage system enabling the melted heat storage material to be flushed in order to quickly cool the hydride pellets so as to prevent them from being desorbed is joined to the heat storage material capsules.

According to another alternative, the hydride pellets are toric and encapsulated, and sealed toric heat storage material capsules are placed between them.

### DETAILED DESCRIPTION OF THE INVENTION

The invention can be better understood in view of the following description, which refers to the appended drawings relating to non-limiting examples of embodiments of the invention.

FIG. 1 shows a first example of an embodiment of a basic storage module for implementing the invention.

FIG. 2 shows a cartridge including a plurality of hydride pellets and heat storage material capsules.

FIG. 3 shows an example of a diffuser.

FIGS. 4 and 5 show a longitudinal and transverse cross-section view of a tank including a plurality of cartridges.

FIGS. 6 and 7 show cross-section views, respectively of a cartridge and of a basic module according to a second alternative embodiment.

FIG. 8 shows another alternative of such a cartridge.

FIGS. 9 and 10 show another alternative implementing one and three diffusers, respectively.

FIG. 1 shows a cross-section view of a basic hydrogen storage module, for implementing a storage tank according to the invention.

The basic module consists of a pellet 1 made of a hydrogen storage material, reacting by hydriding/dehydriding in order to absorb or release the gaseous hydrogen according to the temperature and pressure.

This material consists, in the example described, of magnesium hydride or alloys and metals capable of forming highly exothermal hydrides, in the form of a ground alloy, added to graphite, to form a powdered material with a very fine particle size, which is then compacted so as to form a solid pellet.

This hydrogen storage pellet can also be made by other combinations, with the general formula Mgₓ B_{y} M_{z} Hₙ with the following specificities:
the x/y ratio is between 0.15 and 1.5;
z is between 0.005 and 0.35;
x+y+z is equal to 1;
M represents at least one of the metals from the group Sc, Ti, V, Cr, Mn, Fe, Co, Ni, Cu and Zn;
n is greater than or equal to 4y.

This hydrogen storage pellet 1 is associated with a washer forming a heat tank 2. This washer includes a phase change material ensuring the heat storage in which the change from the solid phase to the liquid phase absorbs the heat released by the hydriding reaction, and the reverse passage releases this heat during the dehydriding reaction.

The phase change material is, for example, a magnesium and zinc alloy.

Spacers 3 made of a thermally conductive material are implanted in the phase change material. These spacers ensure the mechanical resistance to pressure exerted on the casing containing the heat storage material.

The heat storage material is, in the example described, stored in sealed capsules in contact with the pellets.

The capsule is produced by swaging of a basin 4 having a flat base 5 surrounded by a cylindrical belt 6. A second swaged portion 7 closes this basin 4 after the insertion of spacers 43 and the casting of the phase change material 2.

The cover 7 has an external cavity with a shape complementary to that of the metal hydride pellet 2 so as to promote heat exchanges.

To enable the exchange between the gaseous hydrogen and the pellet 2, a diffuser 8 is arranged on at least one of the front surfaces of the pellet 2. This diffuser has radial passages enabling the diffusion over the front surface of the pellet 2 of the gaseous hydrogen in the chamber containing the pellets 2 and the heat storage elements 3.

This configuration also makes it possible to use a heat transfer fluid intended to compensate for the heat losses and not to provide the necessary heat inputs for the hydriding reaction.

The heat storage material is melted in a casting device and solidified in the form of toruses or washers with a volume slightly lower than that of the capsules intended to receive them.

Thus, for a heat storage material having a composition that is eutectic or close to eutectic, of Zn₂₈Mg₇₂ or Zn_{92.2}Mg_{7.8} (expressed as atom percent), the respective solid densities are 2.84 and 6.42.

For the example Zn₂₈Mg₇₂, the solid density of the alloy is equal to 2.84, while the liquid density is equal to 2.59. When the heat storage material melts, its volume will therefore increase by 8.8%; the capsule should therefore have a capacity greater than 8.8% of the volume of the solid heat storage material if the capsule is vacuum-sealed.

If the capsule is sealed under a normal neutral atmosphere, an excess volume is anticipated, in which, for example, the internal pressure of the gas is equal to the external hydrogen pressure.

The volume of the capsule containing the heat storage material must, under these conditions, be equal to 1.1 times that of the solid heat storage material.

For safety reasons, a very slight excess volume equal to 1.1 times that of the solid heat storage material, which leads to a pressure at heat on the order of 10 atmospheres in the capsule, i.e. an intermediate value that limits stresses on the walls in all of the configurations of the tank.

FIG. 3 shows an example of a diffuser 8.

It consists of an open-work metal disk 9 having radial cut-outs, 10 to 12, with different lengths, as well as through-holes 13.

This new design, ensuring a heat exchange as well as a gaseous hydride/hydrogen exchange at the front and not only radial surfaces, results in much faster exchange kinetics and in particular a much lower cost. For example, the heat to be discharged toward the heat storage material on “n” pellets with a thickness of 2 cm had, in the previous patent application, a front exchange surface:
So=2nπd (expressed in cm)
Where d=diameter of the pellet (in cm)

With the devices according to this invention, there is a front exchange surface:

$$S 1 = 2 n \frac{π {d}^{2}}{4}$$

And the ratio

$$\frac{S 1}{S 0}$$

is equal to

$$\frac{d}{4}$$

That is, for a diameter of 14 cm, a multiplication of the exchange surface by a factor of 3.5.

The exchange kinetic is very significantly increased (from 3 to 10 times) by the very reduced distance over which the heat must pass in the case of this new invention.

Previously, the heat had to start from the center of a cylinder with a diameter of 14 cm to reach the periphery of same, whereas, according to this invention, it goes from the middle of the pellets with a thickness of around 2 cm to the surface of same.

The distances are therefore generally reduced to a ratio:

d/2e in which e=thickness of the pellet

The previous considerations obviously show the major benefit of the present invention.

To produce the invention, a plurality of systems have been imagined in which it is possible to alternate the hydride and/or alloy or non-hydridized or partially hydridized metal pellets.

MgH₂ can also be encapsulated independently of the heat storage material.

The alternations of pellets 2 and capsules 3 are placed in a cartridge, of which a cross-section view is shown in FIG. 2.

The cartridge consists of a chamber impervious to gaseous hydrogen, resistant to hydrogen pressure and preferably thermally insulated so as to limit heat losses. In some cases, the cartridge is inserted into a chamber receiving a plurality of cartridges so as to form a high-capacity tank, and this tank is thermostatically controlled or thermally insulated.

The cartridge has a tubular body 15 closed by a tightly mounted cover 16 having an opening 17, in the central position in the example described, for the supply and withdrawal of gaseous hydrogen.

An end flange 18 ensures the pressurization of the stack of capsules of heat storage material 3 and hydride pellets 2.

It rests on the cover of the upper capsule. Springs 19 exert a pressure between the internal surface of the cover 16 and the end flange 18.

The shape of this cartridge can be tubular with a flat base. It can also have alternative shapes to improve its mechanical strength and optionally to facilitate the assembly of a plurality of cartridges in order to form a high-capacity tank.

In particular, the base can have a dished shape. In this case, a spacer is placed between the internal curved surface of the cartridge and the lower surface of the lower capsule of the heat storage material.

Another cartridge shape involves a dished cover.

The cartridges can be combined in a tank to enable high-capacity hydrogen storage.

FIGS. 4 and 5 show, respectively, a longitudinal and transverse cross-section view of a tank including a plurality of cartridges.

It is formed by a thermally insulated chamber 20 in which cartridges 21, 22 are arranged. A conduit 23 connects the cartridge supply openings 21, 22.

Heating elements 24, for example conduits supplied with a heat transfer fluid or electrical resistors, can be provided in order to compensate for the heat losses and keep the cartridges within temperature ranges compatible with the reversible hydriding/dehydriding reaction.

The following description refers to a second embodiment.

FIGS. 6 and 7 show cross-section views, respectively, of a cartridge and of a basic module according to this second alternative embodiment.

The cartridge shown in FIG. 6 includes three basic modules, 31 to 33, with a toric shape.

Each basic module, 31 to 33, includes a capsule, 34 to 36, containing a heat storage material, and a capsule 37, 38 containing a metal hydride.

The heat and hydride storage material capsules are mounted, alternately and coaxially, on a central tubular element 39 ensuring the gaseous hydrogen supply to the capsules 37, 38 containing metal hydride.

FIG. 7 shows a detailed view of a basic module. It includes a first toric capsule 40 formed by two identical crowns 41, 42 welded together after filling with a material such as a zinc-magnesium alloy 43 and placement of a spacer structure 44.

The second toric capsule 45 contains, in the example described, two discoid metal hydride pellets 46, 47 separated by a diffusion washer 48. These pellets 46, and this washer 48 have a central hole for the passage of a gaseous hydrogen supply and withdrawal tube 50. This tube has radial piercings 51, 52. It has a narrowing of the internal cross-section 53 at one of the ends and a narrowing of the external cross-section at the opposite end so as to enable a series of modules to be added by simple juxtaposition, and a cartridge that can be modulated in terms of desired storage capacity, from basic standardized modules, to thus be formed. This reduces the commercial production cost and enables a complete tank line with a reduced number of different components to be proposed.

FIG. 8 shows another alternative of such a cartridge. It has, as in the previous example, a modular structure. The alternation of toric modules is contained in a chamber 60 inside of which a heat transfer fluid supplying the heat modules, 61 to 63, can circulate. This fluid enables limited input heat to be provided, which is insufficient for the energy necessary for the hydriding-dehydriding reaction, but suitable for compensating for heat losses due to thermal insulation defects of the chamber, and for heat losses that occur during filling of the tank.

FIGS. 9 and 10 show another alternative implementing, respectively, one and three diffusers.

Diffusers 8 are inserted between a hydrogen storage element 2 and the heat storage element 3, or between adjacent hydrogen storage elements 2. These diffusers 8 consist of a porous material enabling hydrogen to circulate in the gaseous phase, and having good thermal conductivity.

### KEY TO THE FIGURES

FIGS. 1, 2, 6, 9, 10

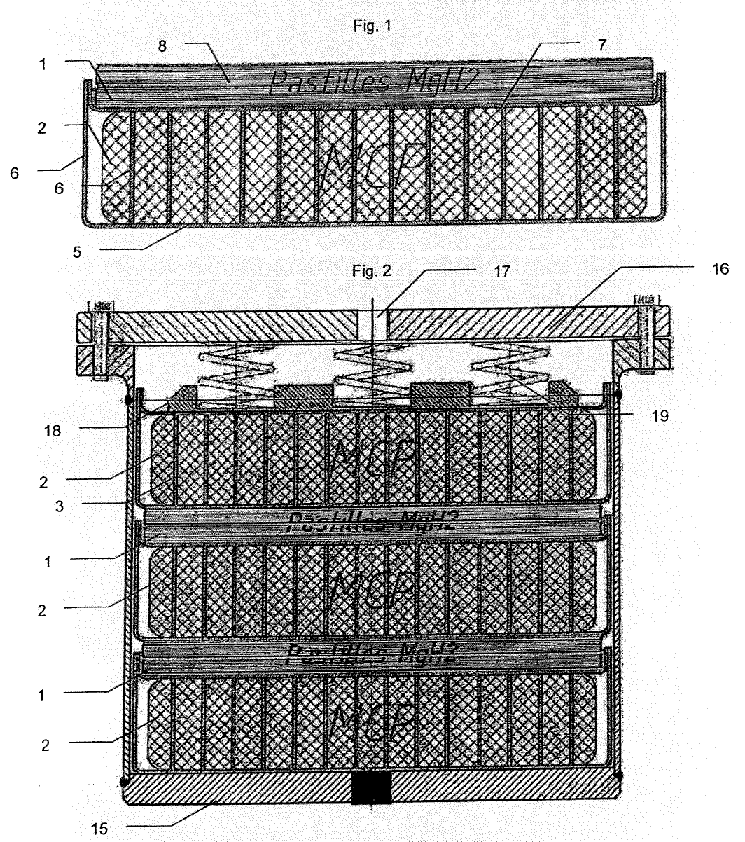

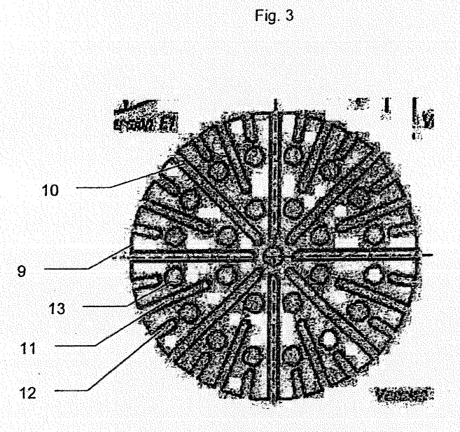

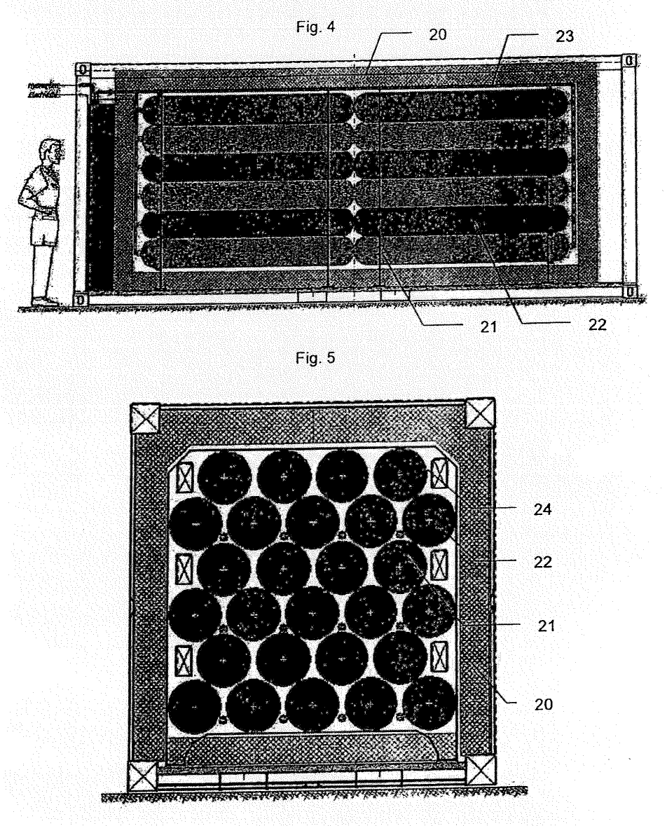

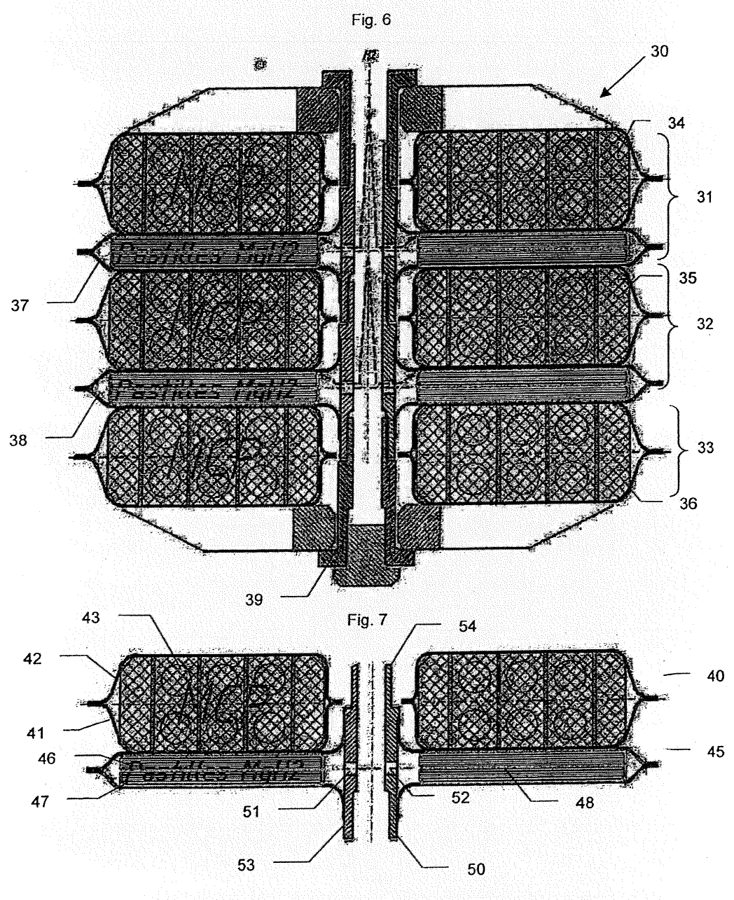

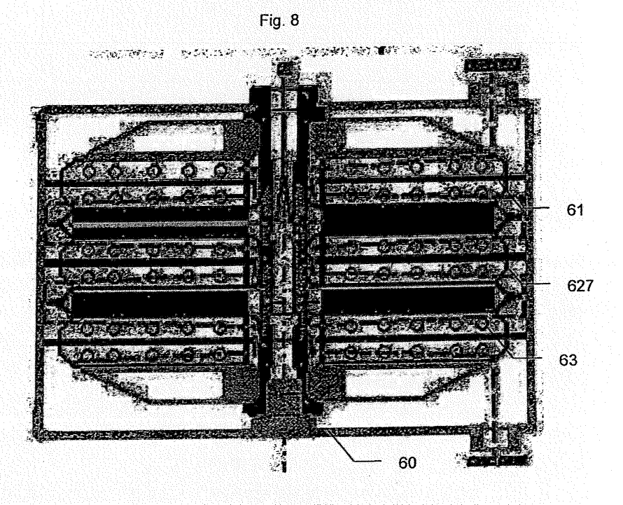

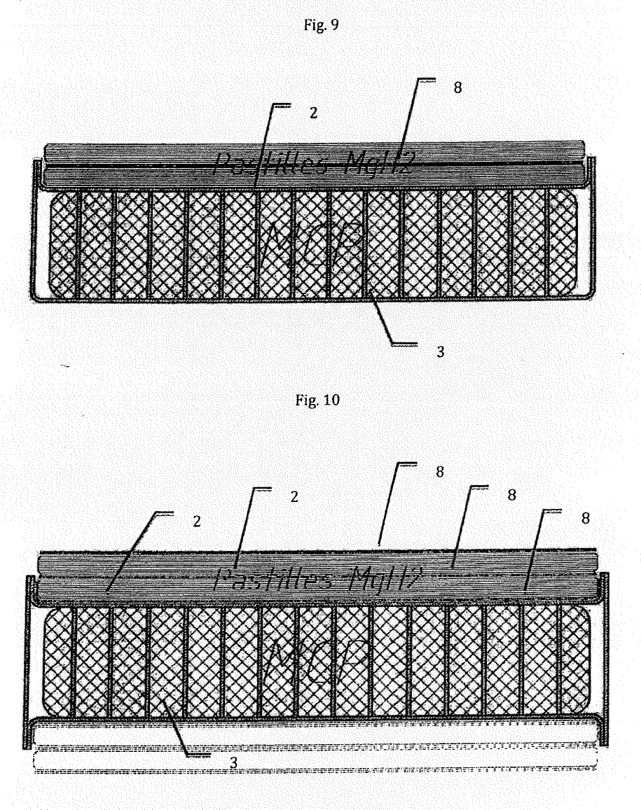

| | |
|---|---|
| Pastilles MgH₂ | MgH₂ pellets |

1. Tank for storing and withdrawing hydrogen by means of a reversible hydriding/dehydriding reaction consisting of a thermally insulated chamber including a plurality of hydrogen storage elements (2) in the form of hydrides each having at least one gaseous hydrogen exchange surface and at least one heat exchange surface, characterized in that it also comprises a plurality of heat storage elements (3) for preserving and withdrawing heat, associated with the reversible hydriding/dehydriding reaction.

2. Tank for storing and withdrawing hydrogen according to claim 1, characterized in that the exchange surfaces between at least one of the heat storage elements (3) and one of said hydrogen storage elements (2) has a front exchange surface with one of said hydrogen storage elements (2).

3. Tank for storing and withdrawing hydrogen according to claim 1, characterized in that the thermal energy necessary for the dehydriding is provided by the heat storage elements (3), and the tank is not associated with any external heat input means other than to compensate for heat losses.

4. Tank for storing and withdrawing hydrogen according to claim 1, characterized in that it consists of a thermally insulated chamber (20) containing at least one cartridge impervious to hydrogen, in which each of said cartridges contains a plurality of hydrogen storage elements (2) each having at least one front hydrogen exchange surface and at least one front heat exchange surface, with said cartridges being connected by at least one conduit for the circulation of the hydrogen.

5. Tank for storing and withdrawing hydrogen according to claim 1, characterized in that the nominal operating temperature is greater than 280° C. and in that said heat storage elements (3) contain a phase change material.

6. Tank for storing and withdrawing hydrogen according to claim 1, characterized in that said phase change material consists of a metal alloy.

7. Tank for storing and withdrawing hydrogen according to claim 1, characterized in that said phase change material consists of a magnesium- and zinc-based alloy.

8. Tank for storing and withdrawing hydrogen according to claim 1, characterized in that said phase change material consists of a salt.

9. Tank for storing and withdrawing hydrogen according to claim 1, characterized in that said hydrogen storage material consists of a pellet of hydrides compacted so as to form a solid block.

10. Tank for storing and withdrawing according to claim 1, characterized in that at least some of said heat storage elements (3) are contained in a casing made of a thermally conductive material acting as a barrier to the hydrogen and which is resistant to the temperatures and corrosion caused by the heat storage materials and by the hydrogen.

11. Tank for storing and withdrawing according to claim 10, characterized in that said heat storage elements (3) contain spacers (43) embedded in the phase change material.

12. Tank for storing and withdrawing according to claim 1 characterized in that at least some of said hydrogen storage elements are contained in a casing made of a thermally conductive material acting as a barrier to hydrogen and which is resistant to the temperatures and corrosion caused by the heat storage materials.

13. Tank for storing and withdrawing according to claim 1 characterized in that the front surface of said casing has protuberances forming spacers between the heat element and the frontally adjacent hydrogen storage element.

14. Tank for storing and withdrawing according to claim 1 characterized in that it comprises a coaxial alternation of hydrogen storage elements (2) and heat storage elements (3).

15. Tank for storing and withdrawing according to claim 1 characterized in that said heat storage elements (3) and said hydrogen storage elements (2) are flat volumes, with a discoid shape.

16. Tank for storing and withdrawing according to claim 1, characterized in that said heat storage elements (3) and said hydrogen storage elements (2) are flat volumes, with a tonic shape.

17. Tank for storing and withdrawing according to claim 1 characterized in that said heat storage elements (3) and said hydrogen storage elements (2) are flat volumes, with a transverse polygonal cross-section.

18. Tank for storing and withdrawing according to claim 1 chracterized in that said hydrogen storage elements (2) and said heat storage elements (3) have a tubular shape.

19. Tank for storing and withdrawing according to claim 1, characterized in that said heat storage elements and said hydrogen storage elements (2) are inserted by diffusers (8) made of a thermally conductive material and having hydrogen supply passages.

20. Tank for storing and withdrawing according to claim 1, characterized in that the hydrogen storage elements (2) are separated frontally by spacers containing a heat transfer material supplied by a heat source of which the power is limited to compensation for heat losses.

21. Tank for storing and withdrawing according to claim 1, characterized in that it consists of a plurality of cartridges each containing a stack formed by an alternation of hydrogen storage elements and heat elements, with said tank comprising a thermally insulated external casing (20), in which said casing is passed through by a single hydrogen conduit and each cartridge is supplied by a single hydrogen conduit.

22. Tank for storing and withdrawing according to claim 1, characterized in that said cartridge consists of a tubular chamber, having a hydrogen supply opening and defining an internal hydrogen circulation volume, in which a stack of alternating hydrogen storage and heat elements compressed together by at least one spring is arranged.

23. Tank for storing and withdrawing according to claim 1, characterized in that it includes modules consisting of at least one hydrogen storage element and at least one spacer enabling the passage of a heat transfer fluid, which are thermally coupled.

24. Tank for storing and withdrawing according to claim 9, characterized in that the hydrogen storage elements and the heat exchange elements have a planar shape and have at least one through-opening for the passage of a hydrogen supply tube.

25. Tank according to claim 1, characterized in that said hydride pellets are toric and encapsulated, and sealed toric phase change alloy capsules preformed by smelting are placed between them.

26. Tank according to claim 1, characterized in that a light excess volume is provided in the heat storage material capsules in order to maintain a significant pressure after the fusion of the heat storage material in order to balance the external pressure during the hydriding/dehydriding.

27. Tank according to claim 1, characterized in that the volume of the heat storage material is adjusted so that the differential pressure between the two sides of the capsule walls is adapted to the mechanical and thermal characteristics of the capsules.

28. Tank according to claim 1, characterized in that a drainage system enabling the melted heat storage material to be flushed in order to quickly cool the hydride pellets so as to prevent them from being desorbed is joined to the heat storage material capsules.

29. Tank according to claim 1, characterized in that the hydride pellets are toric and encapsulated, and sealed toric heat storage material capsules are placed between them.
